(19) United States
(12) Patent Application Publication
(10) Pub. No.: US 2025/0067766 A1
(43) Pub. Date: Feb. 27, 2025

(54) METHOD OF LONGITUDINAL ACCELEROMETER RATIONALIZATION WITH A WHEEL SPEED SENSOR

(71) Applicant: FCA US LLC, Auburn Hills, MI (US)

(72) Inventors: Mohammed Nadeem Akhtar, Canton, MI (US); Scott E Henson, Chelsea, MI (US); Stephanie R Beck, Pickney, MI (US); Roger C Sager, Munith, MI (US); Anthony N Gorney, Oxford, MI (US)

(21) Appl. No.: 18/454,937

(22) Filed: Aug. 24, 2023

(51) Int. Cl. G01P 21/00; G07C 5/08

(52) U.S. Cl. CPC G01P 21/00; G07C 5/08

(57) ABSTRACT

A method of rationalizing operation of a vehicle longitudinal accelerometer is provided. The method includes the steps of receiving an output signal from a wheel speed sensor, receiving an output signal from a longitudinal accelerometer, determining whether an acceleration event exists based on the output signal from the wheel speed sensor, evaluating the longitudinal accelerometer sensor output signal during the acceleration event, and determining whether the longitudinal accelerometer sensor signal exceeds a set threshold value during the acceleration event.

### FIELD

The present disclosure relates to a method of rationalizing vehicle sensors and, more particularly, rationalizing a longitudinal accelerometer with a wheel speed sensor.

### BACKGROUND

Vehicles include a propulsion system that drives the vehicle wheels, resulting in vehicle acceleration. Vehicle speed and acceleration may be measured by sensors and the data generated by the sensors may be provided to one or more vehicle systems. A need exists to rationalize or verify the operational status of the sensors to ensure the sensors are functioning properly.

### SUMMARY

In at least some implementations, a method of rationalizing a vehicle longitudinal accelerometer, the method includes the steps of: receiving an output signal from a wheel speed sensor;
receiving an output signal from a longitudinal accelerometer;
determining whether an acceleration event exists based on the output signal from the wheel speed sensor;
evaluating the longitudinal accelerometer sensor output signal during the acceleration event; and
determining whether the longitudinal accelerometer sensor signal exceeds a set threshold value during the acceleration event.

In at least some implementations, the control system is configured to continuously and simultaneously receive and record output signals from both the wheel speed sensor and longitudinal accelerometer while the vehicle is moving.

In at least some implementations, the set threshold is zero.

In at least some implementations, the acceleration event exists when the output signal from the wheel speed sensor indicates a change in wheel speed that is greater than a wheel speed threshold.

In at least some implementations, the change of wheel speed is determined by recording a first maximum value at a first inflection point and a second minimum value at a second inflection point, and taking the difference between the first maximum value and second minimum value.

In at least some implementations, a first longitudinal accelerometer sensor signal value is taken when the first maximum value is recorded, and a second longitudinal accelerometer sensor signal value is taken when the second minimum value is recorded.

In at least some implementations, the longitudinal accelerometer sensor is determined to be malfunctioning if the difference between the first longitudinal accelerometer sensor signal value and the second longitudinal accelerometer sensor signal value is zero.

In at least some implementations, the longitudinal accelerometer sensor is determined to not be malfunctioning if the difference between the first longitudinal accelerometer sensor signal value and the second longitudinal accelerometer sensor signal value is not zero.

In at least some implementations, the longitudinal accelerometer sensor is determined to be malfunctioning if the difference between the first longitudinal accelerometer sensor signal value and the second longitudinal accelerometer sensor signal value is less than a threshold magnitude.

In at least some implementations, the method further includes a step of providing an indication of an error when the longitudinal accelerometer sensor signal does not exceed the set threshold during the acceleration event.

In at least some implementations, the indication of an error includes incrementing a fail counter.

In at least some implementations, the indication of an error also includes providing an output in the vehicle indicating that the longitudinal accelerometer is malfunctioning when the fail counter meets a fail counter threshold.

In at least some implementations, the set threshold is greater than zero by at least a nominal noise value for the longitudinal accelerometer sensor output.

In at least some implementations, the set threshold does not vary as a function of the magnitude of the output of the wheel speed sensor.

In at least some implementations, a vehicle system, includes:
a wheel speed sensor adapted to sense a wheel speed and to provide an output signal indicative of the magnitude of wheel speed;
a longitudinal accelerometer adapted to sense an acceleration of a vehicle and to provide an output signal indicative of the magnitude of vehicle acceleration; and
a controller communicatively coupled with the longitudinal accelerometer and the wheel speed sensor and adapted to:
receive an output signal from the wheel speed sensor;
receive an output signal from the longitudinal accelerometer;
determine whether an acceleration event exists that meets a wheel speed threshold based on the output signal from the wheel speed sensor;
evaluate the longitudinal accelerometer sensor output signal during the acceleration event; and
determine whether the longitudinal accelerometer sensor signal is a non-zero value during the acceleration event.

In at least some implementations, the vehicle includes multiple wheels and a separate wheel speed sensor is provided for each wheel of the vehicle.

In at least some implementations, the non-zero value is a set threshold greater than zero.

In at least some implementations, the set threshold does not vary as a function of the magnitude of the output of the wheel speed sensor.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is a schematic diagram of a control system of the vehicle;

FIG. 3 is a graph of acceleration and wheel speed over time; and

FIG. 4 is a flow chart of a method of rationalizing a longitudinal accelerometer with a wheel speed sensor.

### DETAILED DESCRIPTION

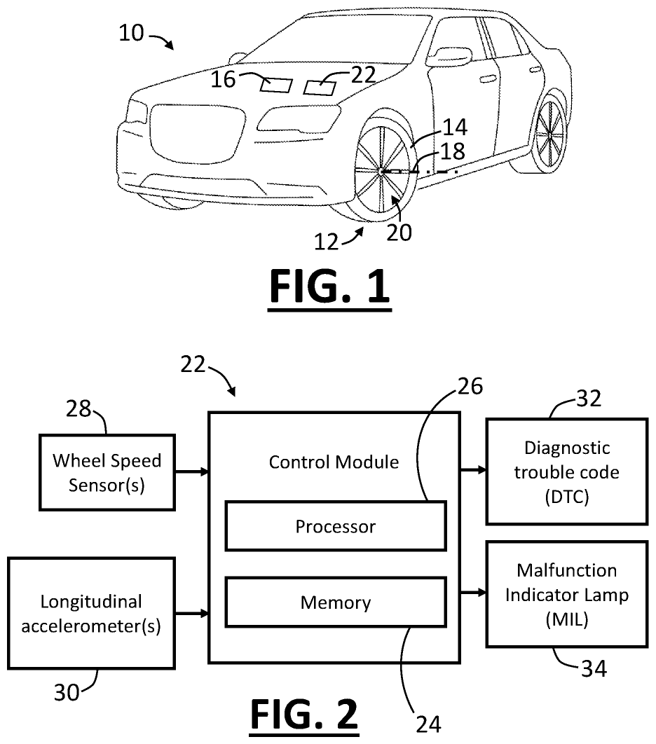

Referring in more detail to the drawings, FIG. 1 illustrates a vehicle 10 that includes multiple wheels 12, and a propulsion system 16 including a motor, an engine, and/or a transmission that provides torque to the wheels 12 to rotate the wheels about an axis of rotation 18 and accelerate the vehicle 10. The vehicle 10 may also include a brake or brake assembly 20 to decelerate the vehicle 10. Vehicle speed and acceleration may be determined by one or more wheel speed sensors 28 (FIG. 2) and/or a longitudinal accelerometer 30. These sensors, among other things, may be communicatively coupled with a controller 22 or control system (e.g., an engine control module). The controller 22 and sensors 28, 30 may be used in control of one or move vehicle functions or systems, like anti-lock brakes, vehicle stability control and the like. The controller 22 may be arranged to receive sensor information and provide information to another system to, for example, trigger diagnostic fault codes for a user in the event of a malfunction of a vehicle component or system (e.g., a malfunctioning vehicle wheel speed sensor or longitudinal accelerometer). The controller 22 may include a memory 24 for storing data from the one or more sensors and a processor 26 for processing the data stored in the memory.

In order to perform the functions and desired processing set forth herein, as well as the computations therefore, the controller 22 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 22 may include input signal processing and filtering to enable accurate sampling and conversion or acquisitions of such signals from communications interfaces and sensors. As used herein the terms controller 22 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

As shown in FIG. 2, to permit measurement of the rotational speed of the wheels 12, the wheel speed sensor 28 may be associated with one of the wheels 12 to provide an output to the controller 22 that is indicative of the rotation of the wheel. The wheel speed sensor 28 may measure rotational speed, acceleration, or both. A separate wheel speed sensor 28 may be associated with each wheel 12. Further, acceleration may be determined by the derivative of rotary speed output(s) from the sensor 28. By way of a non-limiting example, the wheel speed sensor 28 may be a hall effect sensor with a magnet being rotated with the wheel or spindle and with a sensing element used to detect the magnet as it rotates by the sensing element. Of course, other types of rotational speed sensors may be used.

Additionally, acceleration may be measured using the longitudinal accelerometer sensor 30 which measures gravitational forces (i.e., g-forces) in forward and reverse directions, and or other directions. The vehicle 10 may include more than one longitudinal accelerometer 30 arranged in or on the vehicle 10. In at least one embodiment, the longitudinal accelerometer sensor 30 may be a multi-axis accelerometer which provides simultaneous measurement of acceleration in three perpendicular axes, for example. The longitudinal accelerometer 30 may measure normal acceleration which arises when torque is transferred from the propulsion system 16 to the wheels 12 and may also detect decelerating braking forces that arise when the brakes 20 of the vehicle are applied or during engine braking, for example.

One or more systems of vehicle 10 may rely on the wheel speed and vehicle acceleration data from the wheel speed sensor 28 and longitudinal accelerometer sensor 30 during operation or during travel of the vehicle 10. Some systems may be on-board the vehicle and some systems may be remote from the vehicle. For instance, anti-lock braking system (ABS), on-board diagnostic monitors (OBD), torque security features, and/or autonomous vehicle systems (AVS) may utilize some or all of the data from the wheel speed sensor 28 and/or the longitudinal accelerometer 30.

In the event of a malfunction of the wheel speed sensor 28 or longitudinal accelerometer 30, the controller 22 may be configured to send or initiate diagnostic trouble codes (DTC) 32 so that a service technician can identify and diagnosis a specific issue. The controller 22 may additionally, or in the alternative, be configured illuminate a malfunction indicator lamp (MIL) 34 to help indicate a malfunction to a user.

Rationalization of the longitudinal accelerometer 30 with the wheel speed sensor 28 may be performed on one or more and up to all of the longitudinal accelerometers 30 of the vehicle 10. In general, rationalization may confirm whether the longitudinal accelerometer(s) 30 are providing some non-zero output signal, as a predominant failure mode of the longitudinal accelerometer(s) 28 is a total failure in which the sensor provides only a zero-output signal, suggesting no vehicle acceleration is occurring even when the vehicle 10 is accelerating or decelerating. As set forth herein, the rationalization process and method set forth herein may be used as a way to determine that the longitudinal accelerometer 30 is providing a signal without having to determine if the qualitative data from the longitudinal accelerometer 30 is the same as that provided from the wheel speed sensor 28. In other words, determining whether the value or magnitude of the longitudinal accelerometer sensor output is accurate with respect to the wheel speed sensor is unnecessary. Instead, an efficient and economical manner to determine the most common fault or failure mode of the longitudinal accelerometer 30 may involve configuring the controller 22 to require some output from the longitudinal accelerometer 30 when there is a sufficient non-zero output from the wheel speed sensor 28.

The controller 22 may continuously and simultaneously receive and record data from both the wheel speed sensor 28 and longitudinal accelerometer 30 while the vehicle 10 is moving as well as while the vehicle 10 is at rest. Electrical noise and vibrations, for example, may cause the wheel speed sensor 28 and/or the longitudinal accelerometer 30 to produce output signals at the controller 22 which in theory could result in a false indication of a longitudinal accelerometer sensor failure. To ensure that diagnostic evaluation of the longitudinal accelerometer sensor 30 is robust, it may be desirable to configure the controller 22 to only assess and diagnose the longitudinal accelerometer 30 when the wheel speed sensor output signals are of such a magnitude that some response output signal is expected from the longitudinal accelerometer 30 that is clearly distinguishable from a zero-output signal, and noise.

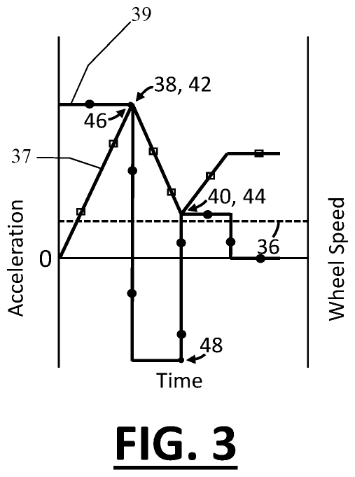

In at least some implementations, a threshold may be used to ensure a sufficient acceleration event exists by which operation of the accelerometer can be checked. For example, in FIG. 3, a wheel speed threshold represented by dashed line 36, which may relate to a minimum change in magnitude, may be used to determine whether a sufficient acceleration event exists for determining operation of the longitudinal accelerometer 30. Wheel speed data from a wheel speed sensor is plotted on line 37 which includes rectangles along the line, and acceleration is shown by line 39 which includes circles along the line for ease in differentiating the two lines. In this example, to determine whether a sufficient acceleration event exists, wheel speed sensor data is monitored until the wheel speed exceeds the threshold 36, and in at least some implementations, the wheel speed threshold must be exceeded for a certain, threshold amount of time. When the wheel speed exceeds the wheel speed threshold 36 for a threshold amount of time, the system may record a first or local maximum value 38 which corresponds the maximum wheel speed recorded during this time and before there is a reduction in wheel speed, which is shown by the inflection point (i.e., when the wheel speed plot line 37 changes direction) at the local maximum value 38. The system may then wait until the wheel speed decreases by at least a second threshold amount from the maximum value 38, and a second or local minimum value 40 may be determined at an inflection point 42 after the threshold magnitude of wheel speed reduction has occurred. Rather than wait for an inflection point, the system may record a second or local minimum value after the wheel speed has reduced below the second wheel speed threshold, which is set to ensure a sufficient change in wheel speed to ensure that the wheel speed sensor is not stuck or producing a static value when it should not be, and to ensure that a sufficient acceleration event has occurred from which the output of the accelerometer can be checked. In some embodiments, an additional or second time threshold may exist where the local maximum value 38 and local minimum value 40 for wheel speed must be recorded within a certain amount of time from one another (e.g., within 5 seconds). The thresholds at different magnitudes or conditions may be used to ensure the wheel speed sensor 28 is not stuck (i.e., malfunctioning) and producing a static value that would not translate to actual vehicle acceleration.

The method or technique described above is intended to ensure that a sufficient acceleration event has occurred from which the accelerometer output can be checked to determine if the accelerometer is functioning. To ensure a sufficient acceleration event is present, other mathematical techniques may be implemented to assess the data and identify a change in magnitude of the wheel speed sensor data. When it is determined that a sufficient acceleration event occurred, and the data points have been recorded, the controller 22 can be used to evaluate whether the longitudinal accelerometer 30 has provided a response at or above an expected magnitude, which may be a response threshold, as set forth in more detail below.

As noted above, the controller 22 may be configured to simultaneously receive and/or record the outputs from the wheel speed sensor(s) 28 and the accelerometer 30. To check operation of the longitudinal accelerometer 30, the controller 22 may be configured to record a first longitudinal accelerometer sensor signal value 46 when the first or maximum wheel speed value 36 is recorded and a second longitudinal accelerometer value 48 when the second or minimum wheel speed value is recorded.

In the example of FIG. 3, the first longitudinal accelerometer sensor signal value 46 is taken (i.e., recorded) when the wheel speed sensor output signal 40 reaches the inflection point 42. Thereafter, a second longitudinal accelerometer sensor signal value 48 is taken (i.e., recorded) when the wheel speed sensor output signal 40 reaches another inflection point inflection point 44. In this example, because the local maximum value 38 is greater than the wheel speed threshold and the local minimum value 40 is less than the local maximum value by more than the second threshold amount, it is determined that a sufficient acceleration event occurred and then the first and second longitudinal accelerometer signal values 46, 48 can be evaluated to determine whether the output from the longitudinal accelerometer satisfies one or more conditions.

In one example, the condition may simply be that neither value 46 or 48 is zero. In one example, a difference between the values 46 and 48 may be evaluated to determine if the difference between them is greater than a predetermined acceleration threshold magnitude. If the first and second longitudinal accelerometer sensor signal values 46, 48 are evaluated and the result is a zero signal value during the acceleration event, or that the signal values 46, 48 do not meet the set threshold magnitude, then a malfunction in the longitudinal accelerometer 30 may be present.

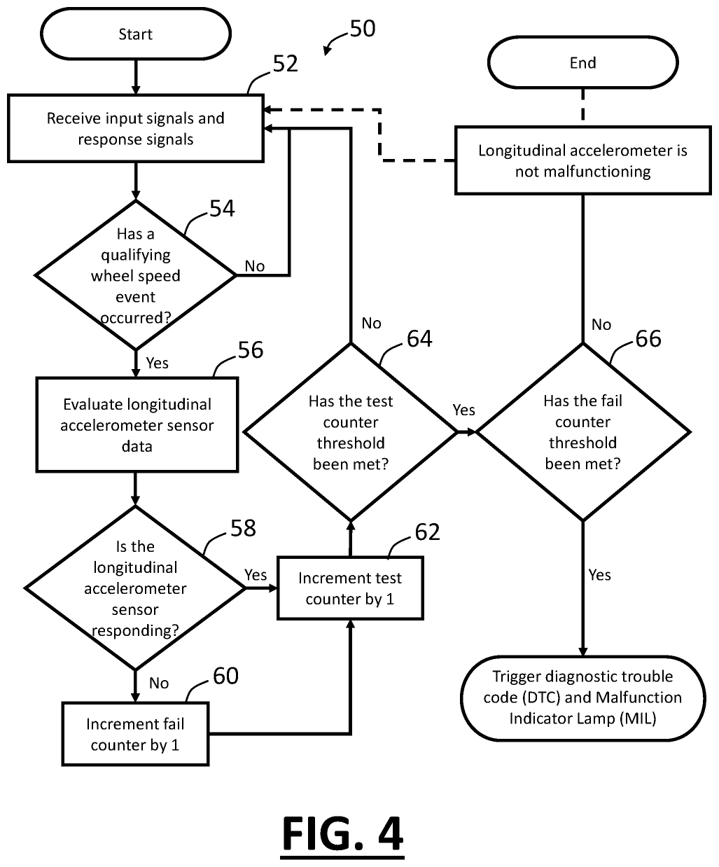

FIG. 4 is a flowchart of a method 50 for rationalizing performance of the longitudinal accelerometer 30 with the wheel speed sensor 28. The method 50 begins with step 52 where output signals from the one or more wheel speed sensors 28 and the longitudinal accelerometer 30 may be provided to and received at the controller 22. The wheel speed sensor output signal may be received at the controller 22 as an input signal and the longitudinal accelerometer output signal may be received at the controller 22 as a response signal.

In step 54 of method 50, depending on how the controller 22 is configured, the controller 22 may evaluate the signals received and determine whether a sufficient acceleration event has occurred. This may be done as described with reference to FIG. 3, and with regard to one or more wheel speed thresholds. If it is determined that a qualifying acceleration event has not occurred, for example because the difference between the maximum and minimum wheel speed values 38, 40 do not meet the criteria, then in step 54 the method returns to step 52 and the controller 22 will continue to receive data from the wheel speed sensor 28 and longitudinal accelerometer 30 until a sufficient acceleration event has occurred at which time the method continues to step 56.

In step 56, the controller 22 assesses the longitudinal accelerometer sensor signal data, such as the first and second longitudinal accelerometer sensor signal values 46, 48 that correspond with when the max and min wheel speed values 38, 40 were recorded. After evaluating the longitudinal accelerometer sensor signal data, the method 50 may continue to step 58 in which the controller 22 determines whether the longitudinal accelerometer 30 is responding properly in light of the acceleration event. This determination may be made, for example, if one or both of the sensor signals 46, 48 is above a set threshold value, if the difference between the sensor signals 46, 48 is above a set threshold value, or if one or both of the sensor signals 46, 48 is not a zero value.

In at least some examples, the set threshold value may be a function of and higher than the typical noise or expected tolerance/inaccuracy of the longitudinal accelerometer 30, which is some nominal value greater than zero. In this way, a very low signal value caused by system noise or the like is not mistaken for a positive output from the longitudinal accelerometer when it is actually providing a zero output value. In at least some implementations, the set threshold value may be a set value and not related to the magnitude of acceleration that occurs during an acceleration event. In other words, the threshold value may remain the same and be used to check operation of the longitudinal accelerometer 30 in acceleration events of varying magnitude. In this way, the accuracy of the output of the longitudinal accelerometer 30 is not being tested, and what is being tested is whether the longitudinal accelerometer is operating and providing a non-zero output.

If in step 58, if the signal data does not meet the set threshold value (e.g., is not equal to or greater than the set threshold, or greater than zero), then the method continues to step 60 and a “fail counter” is incremented by one as a result of the longitudinal accelerometer data not meeting the set threshold. The method then continues to step 62 in which a “test counter” is incremented by one indicating completion of a first test of the longitudinal accelerometer sensor 30. If, on the other hand, the value found in step 56 satisfies the set threshold in step 58, then the longitudinal accelerometer sensor 30 is determined to be functioning properly and the method 50 proceeds directly to step 62 where only the test counter is incremented by one indicating completion of a successful test.

The controller 22 may be programmed to include a test count threshold that must be met (e.g., 2 to 10, by way of non-limiting examples) before the fail counter is evaluated to determine whether a malfunction of the longitudinal accelerometer sensor 30 exists. This can be done to ensure that a desired number of tests have been completed to provide greater confidence in the result. The method 50 may continue to step 64, in which it is determined if the test counter threshold has been met. If the test counter threshold has not been met then the method returns to step 52 to begin another test. If the test counter threshold has been met, then that indicates that there is sufficient data for the controller 22 to make a determination as to the operation of the longitudinal accelerometer sensor 30 and the method continues to step 66.

In step 66, the controller 22 checks the fail counter against a fail counter threshold to determine if a sufficient number of tests indicating failure of the longitudinal accelerometer sensor 30 has occurred to determine that the longitudinal accelerometer sensor is not functioning or is not functioning properly. This may be desirable ensure that the method 50 is robust and only indicates a malfunction when multiple tests indicate sensor malfunction. If, in step 66, the fail counter does not exceed the fail counter threshold then the controller 22 determines that the longitudinal accelerometer is not malfunctioning and the method 50 either ends or returns to step 52 (as shown by the dashed lines in FIG. 4) to start a new sequence of tests, if desired. If, in step 66, the fail counter exceeds the fail counter threshold then the method continues to step 68 in which an error is indicated, such as a diagnostic trouble code 32 (DTC) or illumination of a corresponding malfunction indicator lamp 34. The DTC 32 may be an error code which may be read by a service technician and the malfunction indicator lamp 34 (e.g., check engine light) may be provided to indicate to a user that the vehicle 10 needs to be serviced.

The fail counter threshold may be set at any desired level relative to the test counter threshold. For example, if the test counter threshold is set to 10, then the fail counter threshold may be 10 or a number less than 10. In at least some implementations, the fail counter threshold value is 100% of the test counter threshold value over the course of at least 3 to 5 tests per vehicle trip, for example.

Of course, a test counter and/or fail counter is not needed and a single malfunction of a longitudinal accelerometer sensor 30 may cause an error to be indicated by the system, if desired. Further, the test and fail counters may be reset at any desired interval, including when the vehicle 10 is shutdown after use, or at any other time such as after a threshold number of tests have been run without a threshold number of failures being indicated. For example, the counter may be reset during any conditions other than a key cycle. A “key cycle” refers to an engine/vehicle key-on followed by an engine/vehicle key-off. Also, the method 50 may be run at any desired frequency or interval, as the vehicle 10 is being used, as desired. For instance, the method 50 may run at least once per trip and evaluate the operation of the longitudinal accelerometer sensor 30 if the acceleration threshold conditions are met.

What is claimed is:

1. A method of rationalizing a longitudinal accelerometer of a vehicle, the method comprising the steps of:
receiving an output signal from a wheel speed sensor;
receiving an output signal from a longitudinal accelerometer;
determining whether an acceleration event exists based on the output signal from the wheel speed sensor;
evaluating the longitudinal accelerometer sensor output signal during the acceleration event; and
determining whether the longitudinal accelerometer sensor signal exceeds a set threshold value during the acceleration event.

2. The method of claim 1, where the control system is configured to continuously and simultaneously receive and record output signals from both the wheel speed sensor and longitudinal accelerometer while the vehicle is moving.

3. The method of claim 1, wherein the set threshold is zero.

4. The method of claim 1, wherein the acceleration event exists when the output signal from the wheel speed sensor indicates a change in wheel speed that is greater than a wheel speed threshold.

5. The method of claim 4, wherein the change of wheel speed is determined by recording a first maximum value at a first inflection point and a second minimum value at a second inflection point, and taking the difference between the first maximum value and second minimum value.

6. The method of claim 5, wherein a first longitudinal accelerometer sensor signal value is taken when the first maximum value is recorded, and a second longitudinal accelerometer sensor signal value is taken when the second minimum value is recorded.

7. The method of claim 6, wherein the longitudinal accelerometer sensor is determined to be malfunctioning if the difference between the first longitudinal accelerometer sensor signal value and the second longitudinal accelerometer sensor signal value is zero.

8. The method of claim 6, wherein the longitudinal accelerometer sensor is determined to not be malfunctioning if the difference between the first longitudinal accelerometer sensor signal value and the second longitudinal accelerometer sensor signal value is not zero.

9. The method of claim 6, wherein the longitudinal accelerometer sensor is determined to be malfunctioning if the difference between the first longitudinal accelerometer sensor signal value and the second longitudinal accelerometer sensor signal value is less than a threshold magnitude.

10. The method of claim 1, further comprising a step of providing an indication of an error when the longitudinal accelerometer sensor signal does not exceed the set threshold during the acceleration event.

11. The method of claim 10 wherein the indication of an error includes incrementing a fail counter.

12. The method of claim 10 wherein the indication of an error also includes providing an output in the vehicle indicating that the longitudinal accelerometer is malfunctioning when the fail counter meets a fail counter threshold.

13. The method of claim 1, wherein the set threshold is greater than zero by at least a nominal noise value for the longitudinal accelerometer sensor output.

14. The method of claim 1, wherein the set threshold does not vary as a function of the magnitude of the output of the wheel speed sensor.

15. A vehicle system, comprising:
a wheel speed sensor adapted to sense a wheel speed and to provide an output signal indicative of the magnitude of wheel speed;
a longitudinal accelerometer adapted to sense an acceleration of a vehicle and to provide an output signal indicative of the magnitude of vehicle acceleration; and
a controller communicatively coupled with the longitudinal accelerometer and the wheel speed sensor and adapted to:
receive an output signal from the wheel speed sensor;
receive an output signal from the longitudinal accelerometer;
determine whether an acceleration event exists that meets a wheel speed threshold based on the output signal from the wheel speed sensor;
evaluate the longitudinal accelerometer sensor output signal during the acceleration event; and
determine whether the longitudinal accelerometer sensor signal is a non-zero value during the acceleration event.

16. The system of claim 15, wherein the vehicle includes multiple wheels and a separate wheel speed sensor is provided for each wheel of the vehicle.

17. The system of claim 15 wherein the non-zero value is a set threshold greater than zero.

18. The system of claim 15 wherein the set threshold does not vary as a function of the magnitude of the output of the wheel speed sensor.
